(19) United States
(12) Patent Application Publication
(10) Pub. No.: US 2021/0116924 A1
(43) Pub. Date: Apr. 22, 2021

(54) DELIVERY SYSTEM AND RECEPTION MANAGEMENT DEVICE

(71) Applicant: TOYOTA JIDOSHA KABUSHIKI KAISHA, Toyota-shi (JP)

(72) Inventors: Yasutaka ETOU, Okazaki-shi (JP); Tomohito MATSUOKA, Nagoya-shi (JP); Nobuyuki TOMATSU, Nagoya-shi (JP); Masanobu OHMI, Kasugai-shi (JP); Manabu YAMAMOTO, Toyota-shi (JP); Suguru WATANABE, Nagoya-shi (JP); Yohei TANIGAWA, Toyota-shi (JP)

(73) Assignee: TOYOTA JIDOSHA KABUSHIKI KAISHA, Toyota-shi (JP)

(21) Appl. No.: 16/933,096

(22) Filed: Jul. 20, 2020

(30) Foreign Application Priority Data
Oct. 16, 2019 (JP) 2019-189723

(51) Int. Cl. G05D 1/02; B60P 3/00; G06Q 10/08

(52) U.S. Cl. CPC G05D 1/0212; G06Q 10/08355; B60P 3/007

(57) ABSTRACT

The ID acquisition unit acquires identification information of a delivered delivery box, or identification information of a transport robot that delivered the delivery box. The whitelist holding unit holds identification information of a receivable delivery box, or identification information of a transport robot permitted to deliver. The receiving determination unit determines, when the acquired identification information of the delivery box or the acquired identification information of the transport robot is held in the whitelist holding unit, to receive the delivery box.

### CROSS-REFERENCE TO RELATED APPLICATION

This application claims priority to Japanese Patent Application No. 2019-189723 filed on Oct. 16, 2019, incorporated herein by reference in its entirety.

### BACKGROUND

### 1. Technical Field

The present disclosure relates to a delivery system in which a transport robot delivers a delivery box, and a reception management device that manages reception of the delivery box delivered by the transport robot.

### 2. Description of Related Art

JP-A-2017-144778 discloses a delivery system that delivers a delivery box, which includes a delivery vehicle configured to carry the delivery box to be delivered to a delivery destination thereon, and a mother vehicle configured to carry the delivery vehicle thereon. In this delivery system, the delivery vehicle moves from an alighting location where the delivery vehicle alights from the mother vehicle to the delivery destination, and then fixes, using a movable member, the delivery box to a delivery box fixture provided at the delivery destination.

### SUMMARY

In the delivery system disclosed in JP-A-2017-144778, the delivery vehicle fixes the delivery box to the delivery box fixture provided at the delivery destination, such that the package can be delivered regardless of the recipient's situation. Since the package can be delivered even when the recipient is absent, the delivery system is highly convenient. However, a package not desired by the recipient may be delivered.

Therefore, an objective of the present disclosure is to construct a system having a function of managing reception of packages.

In order to address the issue stated above, a delivery system according to an aspect of the present disclosure includes a transport robot configured to carry a delivery box and autonomously travel to a destination and a reception management device configured to manage reception of the delivery box at the destination. At least one of the delivery box or the transport robot has identification information with which the delivery box or transport robot can be identified. The reception management device includes a first holding unit configured to hold identification information of a receivable delivery box or identification information of a transport robot permitted to deliver, an acquisition unit configured to acquire identification information of a delivered delivery box or identification information of a transport robot that delivered the delivery box, and a receiving determination unit configured to, when the acquired identification information of the delivery box or the acquired identification information of the transport robot is held in the first holding unit, determine to receive the delivery box.

A reception management device according to another aspect of the present disclosure manages reception of a delivery box delivered by a transport robot having an autonomous traveling function. The reception management device includes a holding unit configured to hold identification information of a receivable delivery box or identification information of a transport robot permitted to deliver, an acquisition unit configured to acquire identification information of a delivered delivery box or identification information of a transport robot that delivered the delivery box, and a receiving determination unit configured to, when the acquired identification information of the delivery box or the acquired identification information of the transport robot is held in the holding unit, determine to receive the delivery box.

With the present disclosure, the system provided with a function of managing reception of the delivery box delivered by the transport robot can be constructed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating an outline of a delivery system according to an example.

FIG. 2A is a perspective view of a transport robot of the example.

FIG. 2B is a perspective view of the transport robot of the example.

FIG. 3A is a perspective view of the transport robot in an upright posture.

FIG. 3B is a perspective view of the transport robot in an upright posture.

FIG. 4 is a perspective view of the transport robot loaded with delivery boxes.

FIG. 5A is a diagram illustrating a relative movement of a main body unit with respect to a traveling mechanism.

FIG. 5B is a diagram illustrating a relative movement of the main body unit with respect to the traveling mechanism.

FIG. 6A is a diagram illustrating a structure of the transport robot.

FIG. 6B is a diagram illustrating the structure of the transport robot.

FIG. 7 is a diagram illustrating functional blocks of the transport robot.

FIG. 8 is a diagram illustrating functional blocks of a reception management device.

FIG. 9 is a diagram illustrating a flow of determining whether the delivery box can be received or not.

### DETAILED DESCRIPTION OF EMBODIMENTS

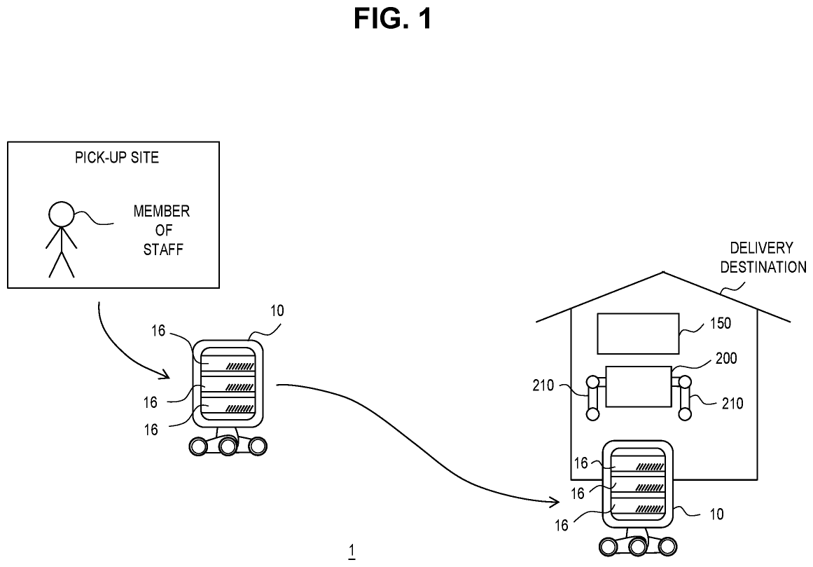

FIG. 1 is a diagram illustrating an outline of a delivery system 1 according to an example. The delivery system 1 includes a transport robot 10 that autonomously travels to a destination (delivery destination) with a delivery box 16 mounted thereon, and a reception management device 200 that manages reception of the delivery box 16 at the destination. For example, the single reception management device 200 may be provided in each home, and the reception management device 200 registers one or more users (for example, members of a family) and manages reception of the delivery box 16 addressed to the registered user.

In the delivery system 1 according to the example, the transport robot 10 is waiting at a pick-up site. When a member of staff at the pick-up site loads the delivery box 16 containing a delivery on the transport robot 10 and inputs the delivery destination, the transport robot 10 autonomously travels to the inputted delivery destination. The travel route may be determined by the transport robot 10, but may be set by an external server device.

The delivery destination is input by a predetermined wireless input tool. When the member of staff inputs the delivery destination from the wireless input tool, a communication unit of the transport robot 10 receives and registers the delivery destination. When the member of staff places the delivery box 16 on the transport robot 10 and inputs the delivery destination, and then instructs the transport robot 10 to start delivery, the transport robot 10 autonomously travels to the input delivery destination. The member of staff may set a plurality of delivery destinations and mount the delivery boxes 16 on the transport robot 10 for each delivery destination.

The reception management device 200 provided at the delivery destination may have a plurality of robot arms 210 to receive the delivery box 16 carried by the transport robot 10. As will be described later, the delivery box 16 and/or the transport robot 10 have identification information, and the reception management device 200 acquires the identification information of the delivery box 16 (box ID) and/or the identification information of the transport robot 10 (robot ID), and determines whether or not to receive the delivery box 16 delivered to the registered user. An RFID tag storing the box ID may be attached to the delivery box 16, and an RFID tag storing the robot ID may be attached to the transport robot 10. When the reception management device 200 determines to receive the delivery box 16, the robot arm 210 receives the delivery box 16 and takes the box into a house through a receiving window 150. As described above, the reception management device 200 manages reception of the delivery box 16, whereby only delivery boxes 16 that are appropriately delivered can be received.

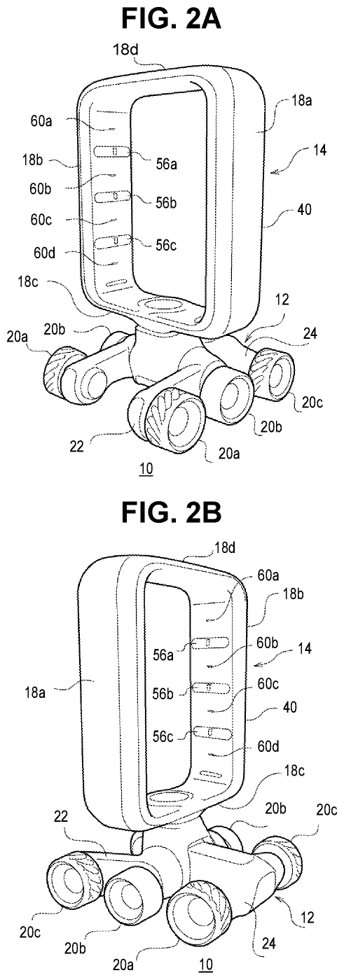

FIGS. 2A and 2B are respective perspective views of the transport robot 10 of the example. A height of the transport robot 10 may be, for example, about 1 to 1.5 meters. The transport robot 10 includes a traveling mechanism 12 having an autonomous traveling function, and a main body unit 14 supported by the traveling mechanism 12 for placing the delivery box 16. The traveling mechanism 12 includes a first wheel body 22 and a second wheel body 24. The first wheel body 22 has a pair of front wheels 20a and a pair of middle wheels 20b, and the second wheel body 24 has a pair of rear wheels 20c. FIGS. 2A and 2B show a state where the front wheel 20a, the middle wheel 20b, and the rear wheel 20c are arranged in a straight line.

The main body unit 14 has a frame 40 formed in a rectangular shape, and a storage space for placing the delivery box 16 thereon is formed inside the frame 40. The frame 40 includes a pair of right and left side walls 18a and 18b, a bottom plate 18c connecting the pair of side walls at a lower side, and a top plate 18d connecting the pair of side walls at an upper side. A pair of opposed ridges (ribs) 56a, 56b, 56c (hereinafter referred to as “ridges 56” unless otherwise specified) are provided on inner surfaces of the right side wall 18a and the left side wall 18b. Further, a pair of opposed locking mechanisms 60a, 60b, 60c, 60d (hereinafter referred to as “locking mechanisms 60” unless otherwise specified) are provided on inner surfaces of the right side wall 18a and the left side wall 18b.

The main body unit 14 is connected to the traveling mechanism 12 so as to be relatively movable. The transport robot 10 of the example has a home delivery function of loading the delivery box 16, autonomously traveling to a set destination, and delivering the delivery box 16 to the reception management device installed at the destination. Hereinafter, regarding the orientation of the main body unit 14, a direction perpendicular to an opening of the frame 40 in a state where the main body unit 14 stands upright with respect to the traveling mechanism 12 is referred to as a “longitudinal direction”, and a direction perpendicular to the pair of side walls is referred to as a “horizontal direction.”

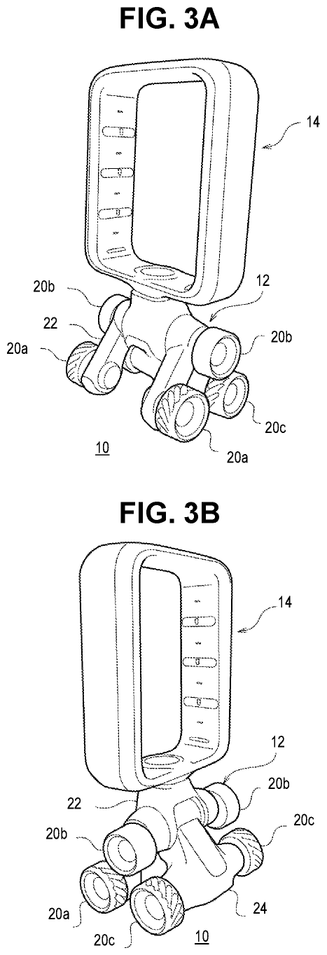

FIGS. 3A and 3B are respective perspective views of the transport robot 10 in an upright posture. The front wheel 20a and the rear wheel 20c in the traveling mechanism 12 approach each other, and the first wheel body 22 and the second wheel body 24 incline with respect to a contact surface, whereby the transport robot 10 transitions to an upright posture.

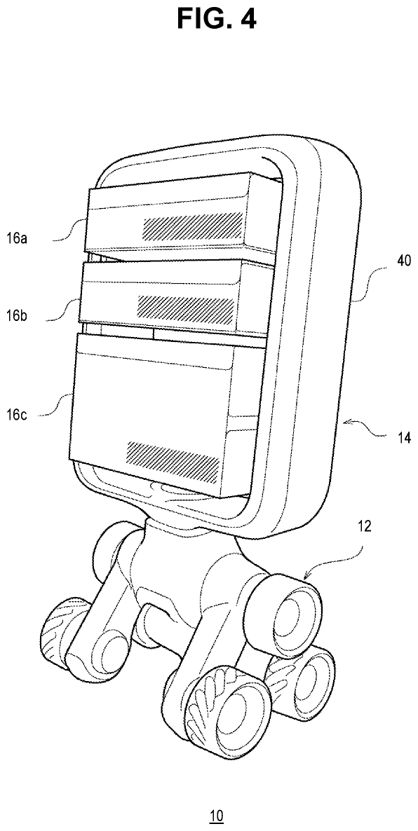

FIG. 4 is a perspective view of the transport robot 10 in an upright posture with the delivery box containing items loaded thereon. FIG. 4 shows that a first delivery box 16a, a second delivery box 16b, and a third delivery box 16c (hereinafter referred to as “delivery boxes 16” unless otherwise specified) are stacked on the main body unit 14. The first delivery box 16a, the second delivery box 16b, and the third delivery box 16c are placed on or engaged with the ridges 56 formed on the inner surfaces of the right side wall 18a and the left side wall 18b, thereby being placed on the main body unit 14. A pair of cutouts are formed on both sides of the delivery box 16, and the locking mechanism 60 inserts lock claws into the cutouts while the delivery box 16 is placed on or engaged with the ridges 56, whereby the delivery box 16 is fixed to the frame 40.

In FIG. 4, the first delivery box 16a, the second delivery box 16b, and the third delivery box 16c are mounted on the main body unit 14, but the object placed on the main body unit 14 is not limited to a box shape. For example, a container for storing the object may be placed on the pair of ridges 56, and the object may be put in the container. Further, a hook may be provided on the inner surface of the top plate 18d of the frame 40, the object may be put in a bag with a handle, and the handle may be hung on the hook, thereby hanging the bag.

Various items other than the delivery box 16 can be stored in a storage space within the frame 40. For example, the transport robot 10 may function as a movable refrigerator by accommodating a refrigerator within the frame 40. Additionally, the transport robot 10 may function as a movable store by accommodating a product shelf on which products are placed within the frame 40.

Each of the first delivery box 16a, the second delivery box 16b, and the third delivery box 16c is a box called a “return box” for storing items, and can be re-used several times. Currently, inexpensive cardboard boxes are often used for delivery of packages, but cardboard boxes are disposed of as garbage after being used for delivery. However, although the return box has a higher unit price than a disposable cardboard box, the return box can be used for a long period of time (for example, 10 years). Thus the return box has a lower total cost and is more environmentally friendly than the use of disposable cardboard boxes for the same period of time. The delivery box 16 has the identification information (box ID) with which the delivery box or transport robot can be identified.

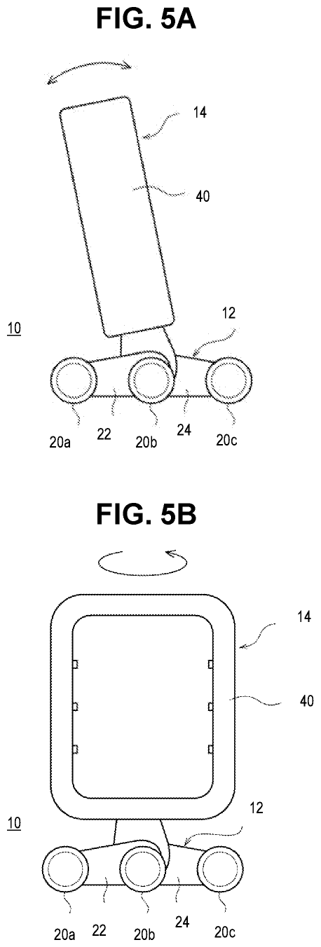

FIGS. 5A and 5B are respective diagrams illustrating a relative movement of the main body unit 14 with respect to the traveling mechanism 12. FIG. 5A shows a state where the side wall of the frame 40 is inclined with respect to a vertical direction. The frame 40 is rotatably supported by a connecting shaft extending in the horizontal direction with respect to the traveling mechanism 12, and can be tilted in any way in the longitudinal direction. By alternately repeating tilt motion in the longitudinal direction, the frame 40 can perform rocking motion in the longitudinal direction.

FIG. 5B shows a state in which the frame 40 has been rotated approximately 90 degrees about a vertical axis. The frame 40 is supported by a connecting shaft extending in the vertical direction with respect to the traveling mechanism 12, and the frame 40 and the traveling mechanism 12 are relatively rotated about the connecting shaft, whereby the frame 40 is rotated as shown in FIG. 5B. The frame 40 may be rotatable by 360 degrees.

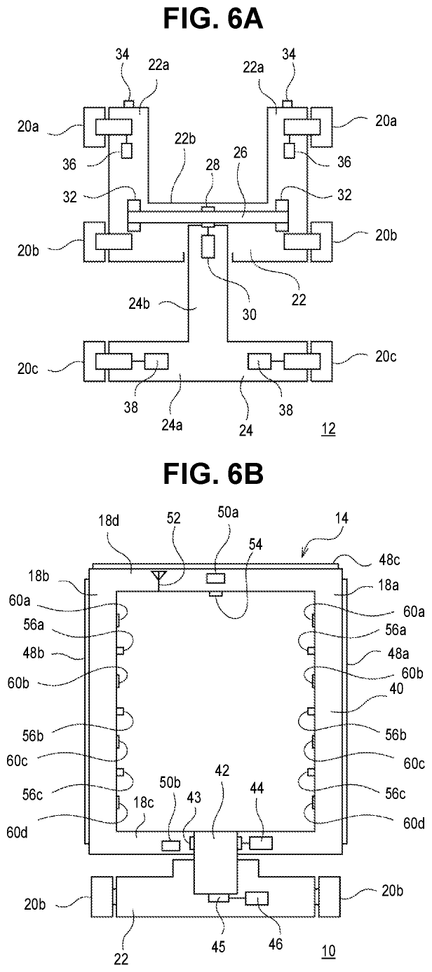

FIGS. 6A and 6B are respective diagrams illustrating a structure of the transport robot 10. FIG. 6A shows the structure of the traveling mechanism 12, and FIG. 6B mainly shows the structure of the main body unit 14. A power supply unit and a control unit are provided in the traveling mechanism 12 and the main body unit 14, but are omitted in FIGS. 6A and 6B.

As shown in FIG. 6A, the traveling mechanism 12 includes the front wheels 20a, the middle wheels 20b, the rear wheels 20c, the first wheel body 22, the second wheel body 24, a shaft body 26, a connection gear 28, an upright actuator 30, a shaft body support unit 32, an object detection sensor 34, a front wheel motor 36 and a rear wheel motor 38.

The first wheel body 22 has a pair of side members 22a and a cross member 22b connecting the pair of side members 22a and extending in a vehicle width direction. The pair of side members 22a are provided to extend in a direction perpendicularly to both ends of the cross member 22b. The pair of front wheels 20a are provided at locations of front ends of the pair of side members 22a, and the pair of middle wheels 20b are provided at locations of both side ends of the cross member 22b. The front wheel motor 36 for rotating a wheel shaft is provided on each of the pair of front wheels 20a.

The second wheel body 24 has a cross member 24a extending in the vehicle width direction, and a connection member 24b extending in a direction perpendicularly to a center position of the cross member 24a. The connection member 24b is inserted into the cross member 22b of the first wheel body 22, and is connected to the first wheel body 22 so as to be relatively rotatable. The rear wheels 20c are provided at both side ends of the cross member 24a.

The rear wheel motor 38 for rotating a wheel shaft is provided on each of the pair of rear wheels 20c. The pair of front wheels 20a and the pair of rear wheels 20c can be independently rotated by the respective motors, and the traveling mechanism 12 can turn left and right by a difference in the rotation amounts between the left and right wheels.

The shaft body 26 extending in the vehicle width direction and the shaft body support unit 32 for supporting both ends of the shaft body 26 are provided within the cross member 22b. The connection member 24b of the second wheel body 24 is rotatably connected to the shaft body 26 by the connection gear 28. The upright actuator 30 can rotate the connection member 24b about the axis of the shaft body 26. The first wheel body 22 and the second wheel body 24 are relatively rotated by driving the upright actuator 30, can transition to upright posture shown in FIGS. 3A and 3B, and can return from an upright posture to a horizontal posture shown in FIGS. 2A and 2B.

The traveling mechanism 12 has a rocker-bogie structure capable of traveling on, for example, steps on a road. The shaft body 26 that connects the first wheel body 22 and the second wheel body 24 is deviated from a wheel shaft of the middle wheel 20b, and is positioned between a wheel shaft of the front wheel 20a and a wheel shaft of the middle wheel 20b in a direction perpendicular to a vehicle width. Consequently, the first wheel body 22 and the second wheel body 24 can be rotate about the shaft body 26 which serves as a fulcrum and the first wheel body 22 and the second wheel body 24 can bend according to a road profile of a road on which the wheels are running.

The object detection sensor 34 is mounted on the first wheel body 22 and detects objects in the traveling direction. The object detection sensor 34 may be a millimeter wave radar, an infrared laser, a sound wave sensor or the like, or alternatively, may be a combination thereof. The object detection sensor 34 may be mounted not only on the front part of the first wheel body 22 but also at various locations on the first wheel body 22 and the second wheel body 24 in order to detect objects in a rearward or lateral direction.

As shown in FIG. 6B, the transport robot 10 includes the frame 40, the connecting shaft 42, an outer peripheral tooth 43, a rotation actuator 44, a connecting shaft 45, a tilt actuator 46, a first camera 50a, a second camera 50b, and a communication unit 52. The frame 40 includes a right display 48a, a left display 48b, a top display 48c (hereinafter referred to as “displays 48” unless otherwise specified), a hook 54, a pair of first ridges 56a, a pair of second ridges 56b, a pair of third ridges 56c, a pair of first locking mechanisms 60a, a pair of second locking mechanisms 60b, a pair of third locking mechanisms 60c, and a pair of fourth locking mechanisms 60d. For better understanding, the connecting shaft 42, the outer peripheral tooth 43, the rotation actuator 44, the connecting shaft 45, and the tilt actuator 46 are simplified and integrally shown in FIG. 6B. However, the connecting shaft 42, the outer peripheral tooth 43 and the rotation actuator 44 may be provided separately from the connecting shaft 45 and the tilt actuator 46.

The ridges 56 are provided so as to protrude from the inner surfaces of the right side wall 18a and the left side wall 18b such that the delivery box 16 can be placed. The locking mechanism 60 is provided such that the lock claw can advance and retreat from the inner surfaces of the right side wall 18a and the left side wall 18b in order to fix the delivery box 16 placed on the ridge 56. A pair of cutouts into which lock claws are inserted are provided on both side surfaces of the delivery box 16. When the locking mechanism 60 inserts the lock claws into the cutouts of the delivery box 16, the delivery box 16 is securely fixed to the frame 40 and cannot be removed. When the locking mechanism 60 retreats the lock claws from the cutouts, the fixed delivery box 16 is released from the frame 40.

The delivery box 16 can be hung on the hook 54 provided on the inner surface of the top plate 18d of the frame 40. The hook 54 may always be exposed from the inner surface of the top plate of the frame 40, but may be provided so as to be accommodated in the inner surface of the top plate so that the hook 54 can be taken out when needed.

The right display 48a is provided on an outer surface of the right side wall 18a, the left display 48b is provided on an outer surface of the left side wall 18b, and the top display 48c is provided on an outer surface of the top plate 18d. The bottom plate 18c and the top plate 18d are provided with the first camera 50a and the second camera 50b (hereinafter referred to as “cameras 50” unless otherwise specified). It is preferable that the transport robot 10 be equipped with a camera in addition to the first camera 50a and the second camera 50b so as to monitor surrounding situations. The camera 50 may be provided at a location where an image of the storage space of the frame 40 can be captured. The communication unit 52 is further provided on the top plate 18d, and the communication unit 52 can communicate with an external server device via a wireless communication network.

The bottom plate 18c is rotatably attached to the outer peripheral tooth 43 of the connecting shaft 42 via a gear (not shown) on a side of the rotation actuator 44, and is connected to the first wheel body 22 by the connecting shaft 42. The rotation actuator 44 rotates the frame 40 about the axis with respect to the connecting shaft 42 by relatively rotating the outer peripheral tooth 43 and the gear. The rotation actuator 44 allows the frame 40 to be rotated as shown in FIG. 5B.

The tilt actuator 46 rotates the connecting shaft 45 so as to tilt the connecting shaft 42 with respect to the vertical direction. The connecting shaft 45 extending in the horizontal direction is provided integrally with a lower end of the connecting shaft 42, and the tilt actuator 46 rotates the connecting shaft 45 to achieve a tilting motion of the connecting shaft 42. By tilting the connecting shaft 42, the tilt actuator 46 can tilt the frame 40 in the longitudinal direction as shown in FIG. 5A.

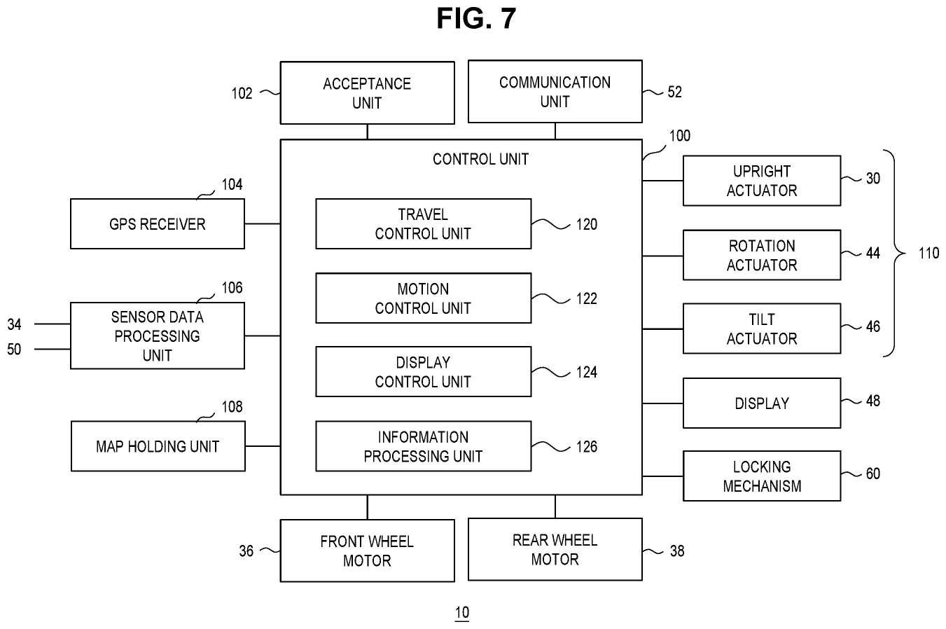

FIG. 7 is a diagram illustrating functional blocks of the transport robot 10. The transport robot 10 includes a control unit 100, an acceptance unit 102, a communication unit 52, a GPS (Global Positioning System) receiver 104, a sensor data processing unit 106, a map holding unit 108, an actuator mechanism 110, the display 48, the locking mechanism 60, the front wheel motor 36, and the rear wheel motor 38. The control unit 100 includes a travel control unit 120, a motion control unit 122, a display control unit 124, and an information processing unit 126. The actuator mechanism 110 includes the upright actuator 30, the rotation actuator 44, and the tilt actuator 46. The communication unit 52 has a wireless communication function, can communicate with a communication unit of the reception management device 200, and can receive information transmitted from a wireless input tool of the member of staff at the pick-up site. The GPS receiver 104 detects a current location based on a signal from a satellite.

In FIG. 7, each component stated as a functional block for performing various processes can be configured by a circuit block, a memory, and other LSIs in terms of hardware, or alternatively, configured by a program loaded into the memory in terms of software. Therefore, it will be apparent to those skilled in the art that those functional blocks can be implemented in various forms by hardware only, software only, or a combination thereof, but not limited to any one of them.

The map holding unit 108 holds map information indicating a road location. The map holding unit 108 may hold not only the road location but also map information indicating a passage location on each floor in a multi-story building such as a commercial facility.

In the delivery system 1 according to the example, the transport robot 10 is waiting at a pick-up site. When the member of staff at the pick-up site inputs at least one delivery destination using the wireless input tool, the communication unit 52 receives the delivery destinations and notifies the travel control unit 120. The wireless input tool may be a dedicated remote controller, or may be a smartphone on which a dedicated application is installed. The transport robot 10 includes an interface for inputting the delivery destination, and the member of staff may input the delivery destination from the interface. For example, when the display 48 is configured as a touchscreen, the display control unit 124 may display a delivery destination input screen on the display 48, and the member of staff may input the delivery destination on the delivery destination input screen. When the acceptance unit 102 accepts a touch operation on the touchscreen, the information processing unit 126 specifies the delivery destination from a touch position and notifies the travel control unit 120.

When the member of staff places the delivery box 16 on the frame 40 and inputs the delivery destination, the information processing unit 126 registers the delivery destination in association with the box ID of the delivery box 16. At this time, the information processing unit 126 activates the locking mechanism 60 for the delivery box 16 so as to fix the delivery box 16 to the frame 40, and generates a passcode for releasing the lock by the locking mechanism 60. In the delivery system 1, the generated passcode is transmitted from the communication unit 52 to an external management server, and the management server transmits the passcode to the reception management device 200 at the delivery destination. The locking mechanism 60 fixes the delivery box 16 to the frame 40, so that the delivery box 16 does not fall out during traveling and is not removed by a third party who is not a recipient.

When the member of staff places the delivery box 16 on the frame 40 and inputs the delivery destination, and then instructs the transport robot 10 to start delivery, the travel control unit 120 autonomously travels to the set delivery destination. The travel route may be determined by the transport robot 10, but may be set by an external server device.

The travel control unit 120 controls the traveling mechanism 12 to travel on the set travel route using the map information held in the map holding unit 108 and the current location information supplied from the GPS receiver 104. In particular, the travel control unit 120 drives the front wheel motor 36 and the rear wheel motor 38 to cause the transport robot 10 to travel to the destination (delivery destination).

The sensor data processing unit 106 acquires information about objects existing around the transport robot 10 based on the detected data by the object detection sensor 34 and the image captured by the camera 50, and provides the information to the travel control unit 120. The target object includes static objects such as a structure or a gutter that hinders traveling, and movable objects such as a person or another transport robot 10. The travel control unit 120 determines a traveling direction and a traveling speed so as to avoid collision with other objects, and controls driving of the front wheel motor 36 and the rear wheel motor 38. When the transport robot 10 reaches the destination, the travel control unit 120 causes the transport robot 10 to move to the front of the reception management device 200, and stops driving the motor.

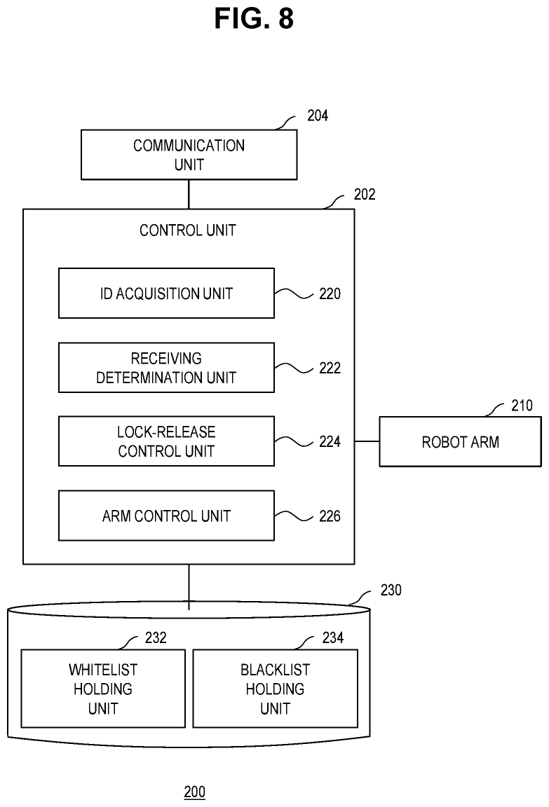

FIG. 8 is a diagram illustrating functional blocks of the reception management device 200. The reception management device 200 includes a control unit 202, a communication unit 204, a robot arm 210, and a holding unit 230. The control unit 202 includes an ID acquisition unit 220, a receiving determination unit 222, a lock-release control unit 224, and an arm control unit 226. The holding unit 230 includes a whitelist holding unit 232 and a blacklist holding unit 234. The communication unit 204 has a wireless communication function and can communicate with the communication unit 52 of the transport robot 10.

In FIG. 8, each component stated as a functional block for performing various processes can be configured by a circuit block, a memory, and other LSIs in terms of hardware, or alternatively, configured by a program loaded into the memory in terms of software. Therefore, it will be apparent to those skilled in the art that those functional blocks can be implemented in various forms by hardware only, software only, or a combination thereof, but not limited to any one of them.

In the delivery system 1, every delivery box 16 has a box ID for uniquely with which the delivery box or transport robot can be identified. When the transport robot 10 transports the delivery box 16 to the delivery destination, the reception management device 200 acquires the box ID of the delivered delivery box 16 and determines whether or not to receive the delivery box 16.

The whitelist holding unit 232 holds the box IDs of one or more receivable delivery boxes 16. The whitelist holding unit 232 may hold, for example, the box ID of a delivery box 16 that is guaranteed to be safely received. An example of a delivery box 16 that can be safely received is a delivery box 16 possessed by a user registered in the reception management device 200, and the whitelist holding unit 232 may hold the box ID of the delivery box 16 possessed by the registered user.

The whitelist holding unit 232 may hold the box ID of the delivery box 16 that is scheduled to be delivered. For example, when a friend sends a package to the user, the whitelist holding unit 232 holds the box ID of the delivery box 16 sent by the friend by notifying the reception management device 200 of the box ID of the delivery box 16 containing the package, in advance.

Further, the whitelist holding unit 232 may hold a part of a code constituting the box ID, specifically, a code (delivery source code) for identifying a delivery source. For example, when groceries are delivered regularly from the supermarket once a week, the whitelist holding unit 232 may hold the delivery source code included in the box ID of the delivery box 16 possessed by the supermarket.

Meanwhile, the blacklist holding unit 234 holds the box IDs of one or more unreceivable delivery boxes 16. The blacklist holding unit 234 may hold the box ID of a delivery box 16 that a user does not want to receive. An example of a delivery box 16 that a user does not want to receive is a delivery box 16 possessed by a store that has forcibly sent a product that the user has not purchased, and the blacklist holding unit 234 may store the box ID of the delivery box 16 or the delivery source code of such a store.

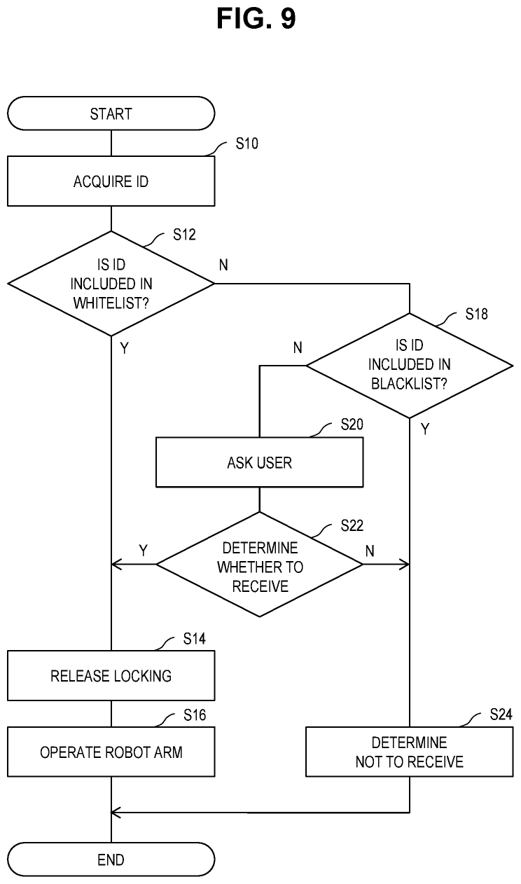

FIG. 9 is a diagram illustrating a flow of determining whether the delivery box 16 can be received or not. When the transport robot 10 loaded with the delivery box 16 addressed to the user stops in front of the reception management device 200 (refer to FIG. 1), the communication unit 52 of the transport robot 10 and the communication unit 204 of the reception management device 200 can communicate. The communication unit 52 and the communication unit 204 may communicate using a wireless LAN function, or alternatively, may communicate via a wireless station of a mobile communication telephone network.

The ID acquisition unit 220 has a function of an RFID reader, and acquires the box ID from the RFID tag attached to the delivery box 16 (S10). When the transport robot 10 has a plurality of delivery boxes 16, the ID acquisition unit 220 acquires a plurality of box IDs. Therefore, the ID acquisition unit 220 may inquire of the transport robot 10 so as to acquire the box ID of the delivery box 16 addressed to the registered user from among the acquired box IDs.

Further, the ID acquisition unit 220 may transmit a request to the transport robot 10 to acquire the box ID of the delivery box 16 addressed to the registered user. In the transport robot 10, the box ID of the delivery box 16 is registered in association with the delivery destination, and the information processing unit 126 transmits the box ID associated with the delivery destination from the communication unit 52 to the reception management device 200. Consequently, the ID acquisition unit 220 may acquire the box ID of the delivery box 16 delivered to the registered user.

The receiving determination unit 222 determines whether or not the box ID acquired by the ID acquisition unit 220 is held in the whitelist holding unit 232 (S12). In a case where the whitelist holding unit 232 holds the delivery source code, the receiving determination unit 222 also determines whether or not the box ID acquired by the ID acquisition unit 220 includes the held delivery source code. In a case where the acquired box ID is held in the whitelist holding unit 232 (YES in S12), the receiving determination unit 222 determines to receive the delivery box 16. A case where the box ID is held in the whitelist holding unit 232 includes a case where the delivery source code of the box ID is held in the whitelist holding unit 232.

When the receiving determination unit 222 determines to receive the delivery box 16, the lock-release control unit 224 transmits, to the transport robot 10, an instruction signal to release the delivery box 16 locked by the locking mechanism 60. This instruction signal includes the passcode for unlocking, which has been transmitted from the management server in advance. When the communication unit 52 receives the instruction signal in the transport robot 10, the information processing unit 126 releases the delivery box 16 locked by the locking mechanism 60 using the passcode included in the instruction signal (S14). After releasing the delivery box 16, the arm control unit 226 controls the robot arm 210 (S16), thereby pulling out the delivery box 16 addressed to the user from the frame 40 and taking the box into the house through the receiving window 150. Therefore, according to the example, only the delivery box 16 addressed to the appropriate user is received by the reception management device 200. When reception of the delivery box 16 is complete, the transport robot 10 moves to another delivery destination.

In S12, in a case where the acquired box ID is not held in the whitelist holding unit 232 (NO in S12), the receiving determination unit 222 determines whether or not the box ID acquired by the ID acquisition unit 220 is held in the blacklist holding unit 234 (S18). In a case where the blacklist holding unit 234 holds the delivery source code, the receiving determination unit 222 also determines whether or not the box ID acquired by the ID acquisition unit 220 includes the held delivery source code. In a case where the acquired box ID is held in the blacklist holding unit 234 (YES in S18), the receiving determination unit 222 determines not to receive the delivery box 16 (S24). A case where the box ID is held in the blacklist holding unit 234 includes a case where the delivery source code of the box ID is held in the blacklist holding unit 234. The transport robot 10 is notified that the delivery box 16 will not be received, and thus the transport robot 10 moves to another delivery destination.

In S18, in a case where the acquired box ID is not held in the blacklist holding unit 234 (NO in S18), the receiving determination unit 222 asks the user to determine whether or not to receive the delivery box (S20). For example, the receiving determination unit 222 may transmit, to a portable terminal device such as a user's smartphone, information on, for example, an owner of the delivered delivery box 16 or a delivery requester. When the user permits the delivery box 16 to be received (YES in S22), the lock-release control unit 224 transmits a lock-release instruction signal to the transport robot 10, and the information processing unit 126 releases the lock of the delivery box 16 (S14). The arm control unit 226 operates the robot arm 210 to take the delivery box 16 into the room from the receiving window 150 (S16).

If the user refuses to receive the delivery box 16 (NO in S22), the receiving determination unit 222 determines not to receive the delivery box 16 (S24). The transport robot 10 is notified that the delivery box 16 will not be received, and thus the transport robot 10 moves to another delivery destination.

In the example stated above, the receiving determination unit 222 determines whether to receive the delivery box 16 or not based on the box ID of the delivery box 16 addressed to the user. In another example, the receiving determination unit 222 may determine whether to receive the delivery box 16 or not based on the robot ID of the transport robot 10.

In the delivery system 1, every transport robot 10 has a robot ID with which the delivery box or transport robot can be uniquely identified. When the transport robot 10 transports the delivery box 16 to the delivery destination, the reception management device 200 acquires the robot ID of the transport robot 10 and determines whether or not to receive the delivery box 16.

The whitelist holding unit 232 holds the robot IDs of one or more transport robots 10 that are permitted to deliver the delivery box 16. The whitelist holding unit 232 may hold the robot ID of the transport robot 10 having high reliability. An example of a highly reliable transport robot 10 is a transport robot 10 possessed by a delivery company trusted by the user, and the whitelist holding unit 232 may hold the robot ID of the transport robot 10 possessed by the delivery company.

Meanwhile, the blacklist holding unit 234 holds the robot IDs of one or more transport robots 10 that are prohibited from delivering the delivery box 16. The blacklist holding unit 234 may hold the robot ID of the transport robot 10 having low reliability. An example of a less reliable transport robot 10 is a transport robot 10 possessed by a delivery company not trusted by the user, and the blacklist holding unit 234 may hold the robot ID of the transport robot 10 possessed by the delivery company.

Referring to the flowchart of FIG. 9, when the transport robot 10 loaded with the delivery box 16 addressed to the user stops in front of the reception management device 200, the ID acquisition unit 220 acquires the robot ID of the transport robot 10 (S10). The ID acquisition unit 220 has a function of the RFID reader, and may acquire the robot ID from the RFID tag attached to the transport robot 10, or alternatively, may acquire the robot ID of the transport robot 10 via the communication unit 204.

The receiving determination unit 222 determines whether or not the robot ID acquired by the ID acquisition unit 220 is held in the whitelist holding unit 232 (S12). In a case where the acquired robot ID is held in the whitelist holding unit 232 (YES in S12), the receiving determination unit 222 determines to receive the delivery box 16.

When the receiving determination unit 222 determines to receive the delivery box 16, the lock-release control unit 224 transmits, to the transport robot 10, an instruction signal to release the delivery box 16 locked by the locking mechanism 60. This instruction signal includes the passcode for unlocking, which has been transmitted from the management server in advance. When the communication unit 52 receives the instruction signal in the transport robot 10, the information processing unit 126 releases the delivery box 16 locked by the locking mechanism 60 using the passcode included in the instruction signal (S14). After releasing the delivery box 16, the arm control unit 226 controls the robot arm 210 (S16), thereby pulling out the delivery box 16 addressed to the user from the frame 40 and taking the box into the house through the receiving window 150. Therefore, according to the example, only the delivery box 16 addressed to the appropriate user is received by the reception management device 200. When the delivery box 16 is completely received, the transport robot 10 moves to another delivery destination.

In S12, in a case where the acquired robot ID is not held in the whitelist holding unit 232 (NO in S12), the receiving determination unit 222 determines whether or not the robot ID acquired by the ID acquisition unit 220 is held in the blacklist holding unit 234 (S18). In a case where the acquired robot ID is held in the blacklist holding unit 234 (YES in S18), the receiving determination unit 222 determines not to receive the delivery box 16 (S24). The transport robot 10 is notified that the delivery box 16 will not be received, and thus the transport robot 10 moves to another delivery destination.

In S18, in a case where the acquired robot ID is not held in the blacklist holding unit 234 (NO in S18), the receiving determination unit 222 asks the user to determine whether or not to receive the delivery box (S20). For example, the receiving determination unit 222 may transmit, to a portable terminal device such as a user's smartphone, information on, for example, an owner of the delivered delivery box 16 or the delivery requester. When the user permits the delivery box 16 to be received (YES in S22), the lock-release control unit 224 transmits a lock-release instruction signal to the transport robot 10, and the information processing unit 126 releases the lock of the delivery box 16 (S14). The arm control unit 226 operates the robot arm 210 to take the delivery box 16 into the house from the receiving window 150 (S16).

If the user refuses to receive the delivery box 16 (NO in S22), the receiving determination unit 222 determines not to receive the delivery box 16 (S24). The transport robot 10 is notified that the delivery box 16 will not be received, and thus the transport robot 10 moves to another delivery destination.

It will be apparent to those skilled in the art that the embodiments are merely examples, various modifications can be made to combinations of the components, and such modifications also fall within the scope of the present disclosure.

In FIG. 9, in a case where the identification information is not included in the blacklist holding unit 234 (NO in S18), the receiving determination unit 222 has asked the user to determine whether or not to receive the delivery box. However, it may be determined that the delivery box would be received without asking the user.

In one embodiment, the receiving determination unit 222 determines whether the delivery box 16 can be received or not based on either the box ID or the robot ID. Meanwhile, the receiving determination unit 222 may determine whether the delivery box 16 can be received or not based on both the box ID and the robot ID. In this case, the receiving determination unit 222 may determine to receive the delivery box 16 only when both the box ID and the robot ID indicate that the delivery box 16 can be received.

What is claimed is:

1. A delivery system, comprising:
a transport robot configured to carry a delivery box and autonomously travel to a destination; and
a reception management device configured to manage reception of the delivery box at the destination, wherein:
at least one of the delivery box or the transport robot has identification information with which the delivery box or transport robot can be identified; and
the reception management device includes:
a first holding unit configured to hold identification information of a receivable delivery box, or identification information of a transport robot permitted to deliver;
an acquisition unit configured to acquire identification information of a delivered delivery box, or identification information of a transport robot that delivered the delivery box; and
a receiving determination unit configured to, when the acquired identification information of the delivery box or the acquired identification information of the transport robot is held in the first holding unit, determine to receive the delivery box.

2. The delivery system according to claim 1, further comprising:
a second holding unit configured to hold identification information of an unreceivable delivery box, or identification information of a transport robot prohibited from delivering,
wherein the receiving determination unit is configured to, when the acquired identification information of the delivery box or the acquired identification information of the transport robot is held in the second holding unit, determine not to receive the delivery box.

3. The delivery system according to claim 1, wherein:
the transport robot is configured to fix the delivery box to the transport robot using a locking mechanism; and
the reception management device further includes a lock-release control unit configured to, when the receiving determination unit determines to receive the delivery box, transmit to the transport robot an instruction signal for releasing the delivery box locked by the locking mechanism.

4. A reception management device that manages reception of a delivery box delivered by a transport robot having an autonomous traveling function, comprising:
a holding unit configured to hold identification information of a receivable delivery box, or identification information of a transport robot permitted to deliver;
an acquisition unit configured to acquire identification information of a delivered delivery box, or identification information of a transport robot that delivered the delivery box; and
a receiving determination unit configured to, when the acquired identification information of the delivery box or the acquired identification information of the transport robot is held in the holding unit, determine to receive the delivery box.
